(19) United States
(12) Patent Application Publication
(10) Pub. No.: US 2011/0290428 A1
(43) Pub. Date: Dec. 1, 2011

(54) Vertical tire changing device

(76) Inventor: Philippe Pierre Roussel, Carlsbad, CA (US)

(21) Appl. No.: 12/787,397

(22) Filed: May 26, 2010

(51) Int. Cl. B60C 25/135

(52) U.S. Cl. 157/1.22

(57) ABSTRACT

A tire changing apparatus to remove a tire from a wheel may include a substantially vertical stand for supporting a wheel balancing assembly and the vertical stand supporting a rim locker assembly which is operated by a arm. The rim locker assembly may include an adjustable arm extending device to adjust to different size rims, and the arm extending device may include a base member. The base member may include a spiral slot, and the base member may be driven by a drive gear. The drive gear may be driven by a opposing drive gear, and the opposing drive gear may be connected to a rotating arm.

### FIELD OF THE INVENTION

The present invention relates to a tire changing device and more particularly to a vertical tire changing device.

### BACKGROUND OF THE INVENTION

The present invention relates to a tire-changer device which includes all the component necessary to achieve the dismounting of a tire from a wheel then the mounting of a tire on a wheel and the balancing of the wheel.

The tires used nowdays on light vehicles or motorcycles have become increasing stiff and hard to remove or install without a dedicated mounting machine or tire-changer. Most tire-changer are professionally designed power equipment which are very expensive, alongside with a few mechanical tire-changers machines.

The normal tire-changing procedure involves a table on which the tire is placed horizontally. Mechanical tire-changer machines require the operator to use a mounting bar around a central pivot. The tip of the bar is inserted between the tire and the rim and the operator use a great deal of physical force on the opposite tip of the bar by turning around the wheel. Power tire-changer machines use pneumatic or electric motors to turn the wheel while a mount/dismount head is inserted between the rim and the tire. These tire-changers have in common to be voluminous, to require to be fixed on the ground and occupy an important space even when not in use.

The present tire-changer station invention is organized in such a way that it can be setup vertically, fixed upon a wall or affixed to a vehicule frame, wheel or hitch, or simply stand alone. The vertical setup of the tire changer allows it to be very compact, and requires a smaller space in the work shop. Contrary to the classical floor installation for a tire changer which requires a important foot-print for its installation and the space required around to operate it, the vertical setup saves space in the work shop whether in use or not. The foot print occupied by the present invention is approximately one square foot.

With such a vertical setup, the Tire Changer allows the operator to minimize physical efforts required to operate the device via a more ergonomic working station design. The operator will be using mostly vertical movements which are relayed by lever and drive gear for the most physically demanding operations. The drive gear multiply the force of the operator diminishing the physical stress required for the operation. The operator works in upright position, avoiding bending his back and knees, using his body weight and leg strength to perform the few tasks requiring some manipulation.

The current state-of-art for mechanical tire-changers for locking the rim on the tire changer is to adjust multiple locking points one by one. This process takes time, requires some skill to properly center the wheel, and may need further tightening during the tire changing process to prevent the rim to turn.

The Tire Changer station features a triple rim locker arms connected to an helical plate activated by a lever in such way that

Both rim-locker arms are actuated simultaneously by the lever

The lever is actuated by the operator while maintening the wheel in position toward the rim lockers, inserting the rim clamps in the rim edge and progressively tightening the grip as the locker arms are sliding/tightened toward the rim center.

The locking arms are sliding toward the center simultaneously, assuring a self-centering grip of the rim, actuated by a rotative part including helical sliding guides.

This invention drastically minimize the time needed and difficulty for the operator to adjust the rim locking to the mounting table. Furthermore, the more grip and strength is needed, the more the lever movement will tighten the arms grip on the rim. The lever features a ratchet to allow the operator to focus on the job without modifying his grip on the machine. This ratchet is reversible to disengage the wheel from the clamps at the end of the procedure.

Unlike to mechanical tire-changers which use a lever to dismount or mount the tire on the wheel, the invention uses a dismount/mount head similar to those used by power tire-changers. But unlike these expensive power tire-changers, this head is mounted on a L shape arm which takes hold on the ground base plate of the tire changer, while the head is maintained by the natural pressure existing between the tire and the rim. This setup adjusts automatically to the rim size and self-locks the tool between the tire and the rim while rotating the wheel. Such setup provides the efficiency found on expensive and professional tire stations for a fraction of the price. It makes possible a semi-automatic operation while manually actuated, and leverages the operator strength by using his body weight to actuate a drive gear which turns the wheel while mounting the tire. Its ergonomic reduces greatly the physical stress on the operator.

Tire-changers do not provide a wheel balancing capability, and rely on an additional tool for it. The present invention includes an integrated wheel balancing device. This reduces the global cost of ownership for a complete tire-changing equipment, and minimize the space required in the work shop.

### SUMMARY

A tire changing apparatus to remove a tire from a wheel may include a substantially vertical stand for supporting a wheel balancing assembly and the vertical stand supporting a rim locker assembly which is operated by a arm.

The rim locker assembly may include an adjustable arm extending device to adjust to different size rims, and the arm extending device may include a base member.

The base member may include a spiral slot, and the base member may be driven by a drive gear.

The drive gear may be driven by a opposing drive gear, and the opposing drive gear may be connected to a rotating arm.

The wheel balancing assembly may extend from the center of the drive gear and the tire changing apparatus may include a bead breaking assembly.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a exploded view of a portion of the rim locker assembly of the present invention;

FIG. 2 illustrates a perspective view of the portion of the rim locker assembly of the present invention;

FIG. 3 illustrates an exploded view of the rim locker assembly of the present invention;

FIG. 4 illustrates an exploded view of a portion of the rim locker assembly of the present invention;

FIG. 5 illustrates a perspective view of the portion of the rim locker assembly of the present invention;

FIG. 6 illustrates an exploded view and side view of a portion of the rim locker assembly of the present invention;

FIG. 7 illustrates a side view of the portion of the rim locker assembly of the present invention;

FIG. 8 illustrates a front view of the portion of the rim locker assembly of the present invention;

FIG. 9 illustrates an exploded view of the wheel balancing assembly of the present invention;

FIG. 10 illustrates a side view of the wheel balancing assembly of the present invention;

FIG. 11 illustrates an exploded view of the opposing drive wheel of the rim locker assembly;

FIG. 12 illustrates a perspective view of the opposing wheel drive of the rim locker assembly;

FIG. 13 illustrates a side view of the opposing drive gear of the rim locker assembly of the present invention;

FIG. 14 illustrates an exploded view of the rim locker assembly of the present invention;

FIG. 15 illustrates a perspective view of the rim locker assembly of the present invention;

FIG. 16 illustrates a front view of the rim locker assembly of the present invention;

FIG. 17 illustrates a side view of the rim locker assembly of the present invention;

FIG. 18 illustrates an exploded view of the tire changing apparatus of the present invention;

FIG. 19 illustrates a perspective view of the tire changing apparatus of the present invention;

FIG. 20 illustrates a perspective view of the tire changing apparatus of the present invention;

FIG. 21 illustrates a front view of the tire changing apparatus of the Present invention;

FIG. 22 illustrates a back view of the tire changing apparatus of the present invention;

FIG. 23 illustrates a side view of the tire changing apparatus of the present invention;

FIG. 24 illustrates a top view of the tire changing apparatus of the present invention.

### DETAILED DESCRIPTION

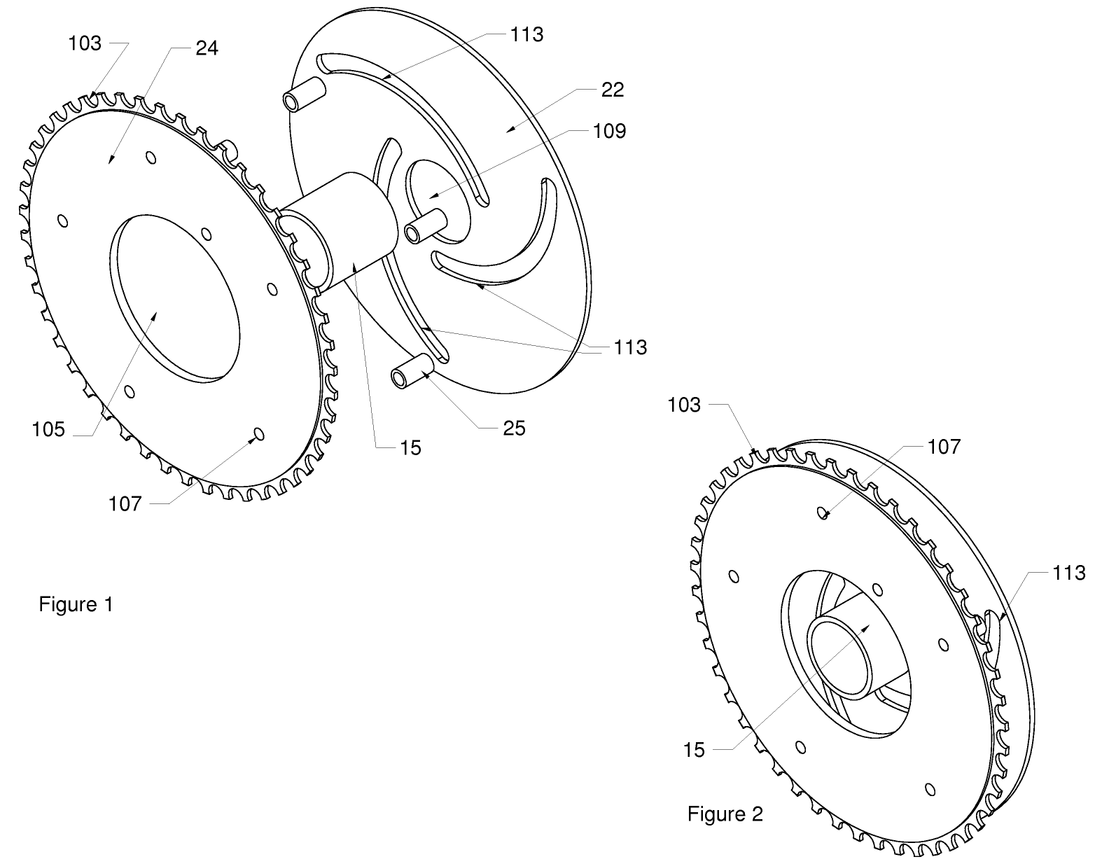

The present invention includes a tire changing apparatus that may include a substantially vertical orientation to provide the user that may be changing the tire a more ergonomic friendly position. The tire may be changed from a substantially vertical position such that the radius of the tire may be in a substantially vertical plane. FIG. 1 illustrates an exploded view of a chain ring or drive gear 24 and a heli coil or arm extending device 22 which may be positioned in a spaced relationship to the drive gear 24. The drive gear 24 may include gear teeth 103 which may extend radially from the periphery of the drive gear 24 and may include a central aperture 105 to cooperate with a support device 15 which may be a cylinder. The drive gear 24 may include mounting apertures 107 to cooperate with a multitude of spacer devices 25 which may axially extend from the arm extending device 22 which may include a central aperture 109 to cooperate with the support device 15 and may include a multitude of spiral slots 113.

FIG. 2 illustrates a perspective view of the drive assembly which may include a chain ring or drive gear 24 and an heli coil or arm extending device 22 which may be positioned in a spaced relationship to the drive gear 24.

The drive gear 24 may include gear teeth 103 which may extend radially from the periphery of the drive gear 24 and may include a central aperture 105 to cooperate with a support device 15 which may be a cylinder. The drive gear 24 may include mounting apertures 107 to cooperate with a multitude of spacer devices 25 which may axially extend from the arm extending device 22 which may include a central aperture 109 to cooperate with the support device 15 and may include a multitude of spiral slots 113.

As the arm extending device 22 rotates in a first direction in cooperation with the drive gear 24 the spiral slots 113 to cooperate with the finger 305 to extend the movable arm 301 outwards. As the arm extending device 22 rotates in a second direction (opposed to the first direction) in cooperation with the drive gear 24, the spiral slots 113 cooperate with the finger 305 to retract the movable arm inwards. As a consequence, the movable arm 301 can be retracted and extended to adjust to different size rims.

An L-shaped platform 315 may include a pair of fingers 319 which may extend from the back surface 331 of the L-shaped platform 315. These fingers 319 may cooperate with apertures 303 which may extend through the movable arm 301. By choosing different apertures 303, the L-shaped platform is adjustably mounted up and down the movable arm 301. A rim holding device 317 may be mounted on the L-shaped platform 315 to adjustably grip a rim of the user's wheel.

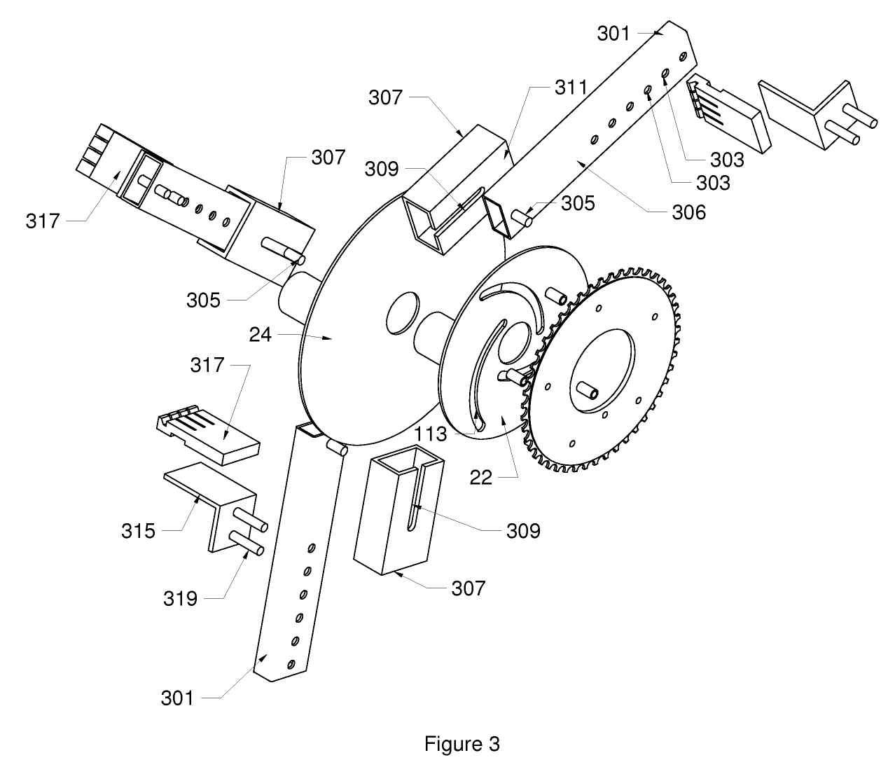

FIG. 3 illustrates among other things the rim locker assembly 300 which may include a base disk member 301 which may be a cylindrical disk and may be connected to a sleeve 307 which may include a slot 309 which may partially extend through the front surface 311 of the sleeve 307. The sleeve 307 may cooperate with a movable arm 301 and the movable arm 301 may include an outward extending finger 305 which extends outwards from the front surface 306 of the movable arm 301 and which may cooperate with the slot 309 of the base member 301 and may cooperate the spiral slots 113 which moves the movable arm 301 radially to adjust for different size tires.

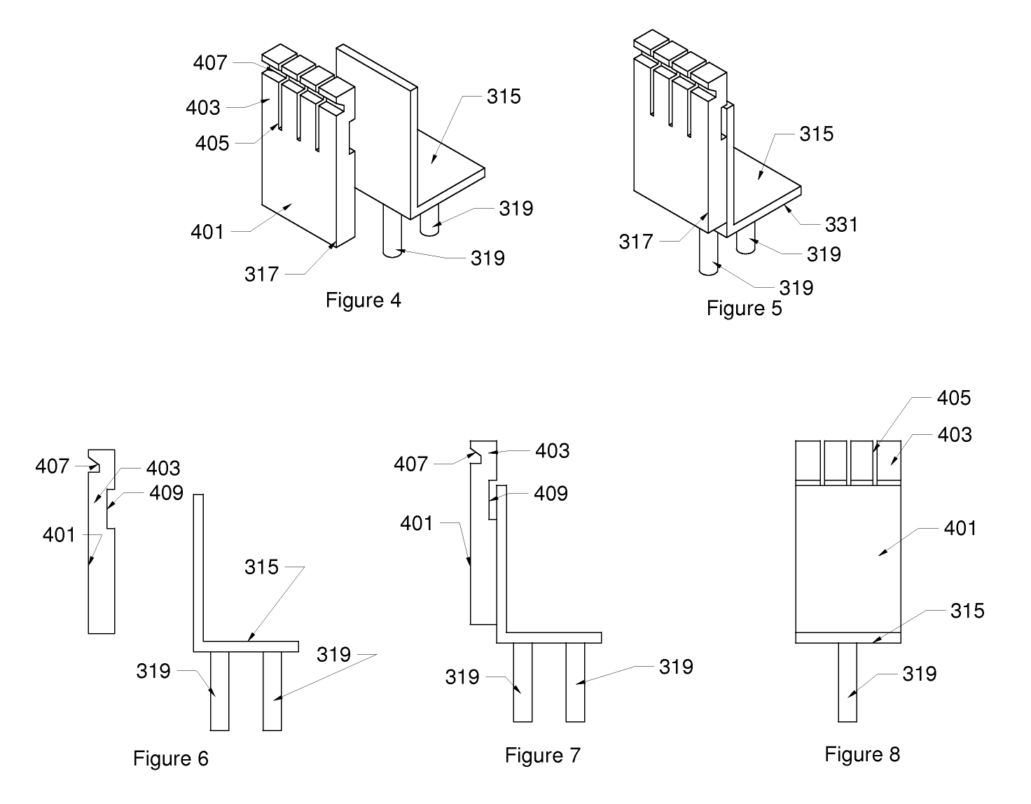

FIG. 4 illustrates a exploded view of the L-shaped platform 315 and the rim holding device 317. An L-shaped platform 315 may include a pair of fingers 319 which may extend from the back surface 331 of the L-shaped platform 315. These fingers 319 may cooperate with apertures 303 which may extend through the movable arm 301. By choosing different apertures 303, the L-shaped platform is adjustably mounted up and down the movable arm 301. A rim holding device 317 may be mounted on the L-shaped platform 315 to adjustably grip a rim of the user's wheel.

The rim holding device 317 may include a base portion 401 and may include a multitude of upward extending rim holding fingers 403 which extend from the base portion 401. A vertical slot 405 may define the rim holding finger 403 and the rim holding finger 403 may include a substantially horizontal channel 407 to cooperate with the rim of the user's wheel.

FIG. 5 illustrates a perspective view of the platform 315 and the rim holding device 317 and may illustrate the base portion 401, the vertical slot 405, the rim holding finger 403 and the channel 407. FIG. 5 additionally illustrates the fingers 319 of the platform 315.

FIG. 6 illustrates a side and exploded view of the platform 315 and the rim holding device 317 and may illustrate the base portion 401, the vertical slot 405, the rim holding finger 403 and the channel 407. FIG. 6 additionally illustrates the fingers 319 of the platform 315. FIG. 6 additionally illustrates a back channel 409 formed in the back surface of the rim holding finger 403 to provide flexibility to the rim holding finger 403.

FIG. 7 illustrates a side view of the platform 315 and the rim holding device 317 and may illustrate the base portion 401, the vertical slot 405, the rim holding finger 403 and the channel 407. FIG. 7 additionally illustrates the fingers 319 of the platform 315. FIG. 7 additionally illustrates a back channel 409 formed in the back surface of the rim holding finger 403 to provide flexibility to the rim holding finger 403.

FIG. 8 illustrates a side and exploded view of the platform 315 and the rim holding device 317 and may illustrate the base portion 401, the vertical slot 405, the rim holding finger 403 and the channel 407. FIG. 8 additionally illustrates the fingers 319 of the platform 315.

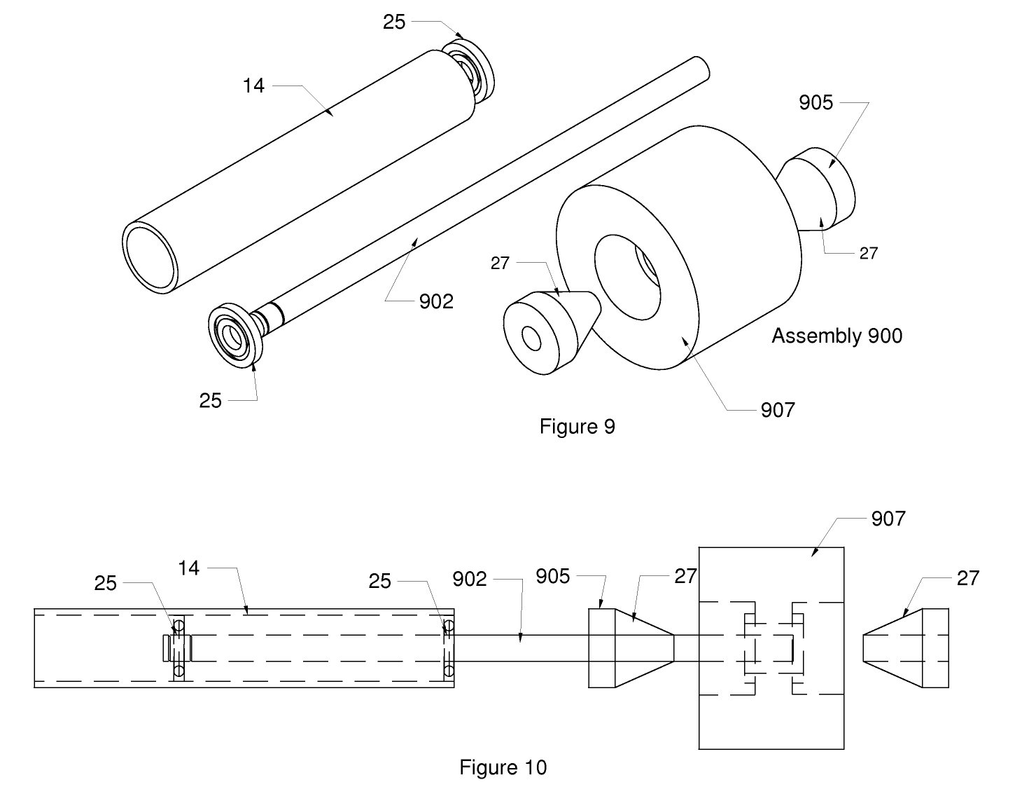

FIG. 9 illustrates a wheel balancer assembly 900 which may include a shaft 902 which may be connected to a bearing 25 and an opposed bearing 25 to maintain a spaced relationship with the sleeve 14. Additionally, a first and second wheel centering devices 27 which may include a truncated cone portion 905 may be positioned on opposing sides of a hub of a wheel 907 of the user in order to obtain a balanced for the wheel.

FIG. 10 illustrates an assembled wheel balancer assembly 900 which may include a shaft 902 which may be connected to a bearing 25 and an opposed bearing 25 to maintain a spaced relationship with the sleeve 14.

Additionally, a first and second wheel centering devices 27 which may include a truncated cone portion 905 may be positioned on opposing sides of a hub of a wheel 907 of the user in order to obtain a balanced for the wheel.

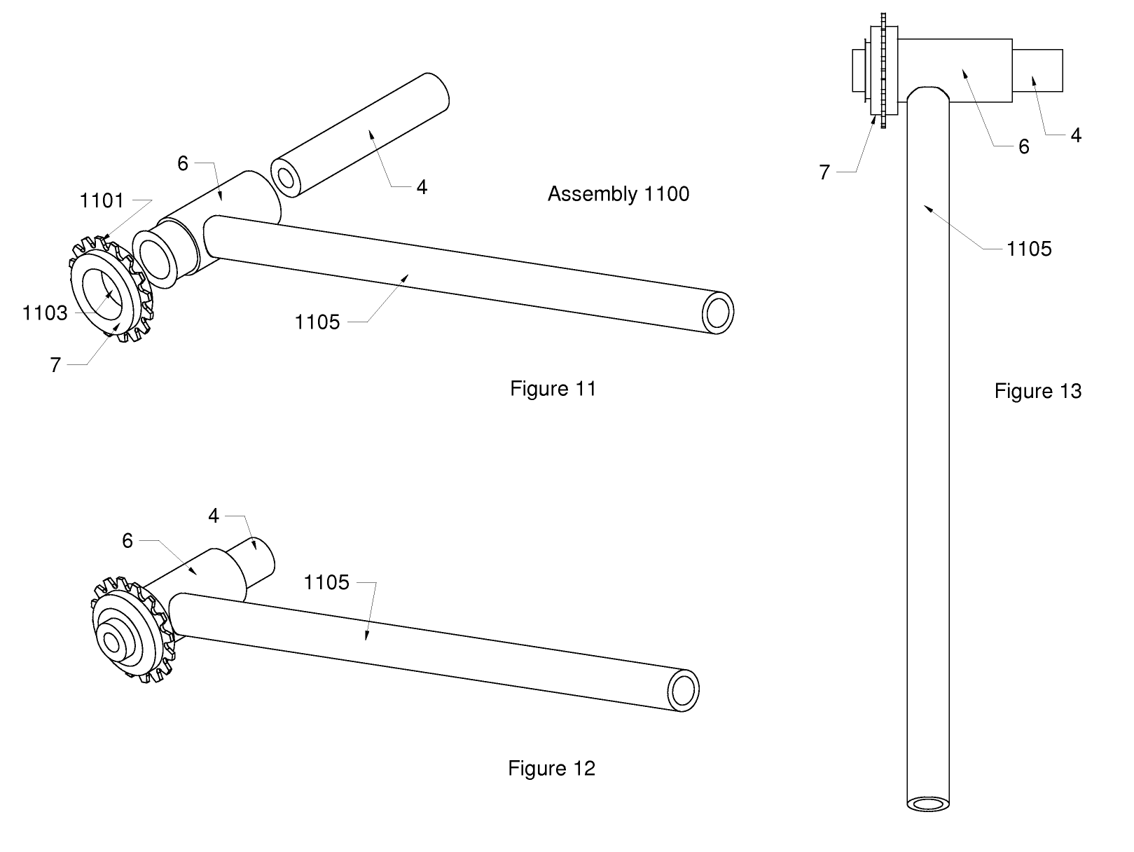

FIG. 11 illustrates a perspective exploded view of a drive assembly 1100 and illustrates an opposing drive gear 7 to cooperate with the drive gear 24 by rotating the drive gear 24. The drive gear 7 may include gear teeth 1101 which may be positioned radially around the periphery of the drive gear 7 and may include a central aperture 1103 to cooperate with a driveshaft 6. An operating arm 1105 may be connected to the driveshaft 6 to rotate the driveshaft 6 and consequently to rotate drive gear 7 and drive gear 24. The drive gear 7 may include a ratchet mechanism to allow the operator to actuate the lever 1105 in clockwise or counterclockwise direction while turning gear 7 and 24 in only one direction.

A second shaft 5 and a third shaft 4 may be axially aligned with the shaft 6 and may extend through the stand 1 which may be connected to a support 2 to support the stand 1 on a support surface such as a garage floor or ground.

FIG. 12 illustrates a perspective view of a drive assembly 1100 and illustrates an opposing drive gear 7 to cooperate with the drive gear 24 by rotating the drive gear 24. The drive gear 7 may include gear teeth 1101 which may be positioned radially around the periphery of the drive gear 7 and may include a central aperture 1103 to cooperate with a driveshaft 6. An operating arm 1105 may be connected to the driveshaft 6 to rotate the driveshaft 6 and consequently to rotate drive gear 7 and drive gear 24.

A second shaft 5 and a third shaft 4 may be axially aligned with the shaft 6 and may extend through the stand 1 which may be connected to a support 2 to support the stand 1 on a support surface such as a garage floor or ground.

FIG. 13 illustrates a side view of a drive assembly 1100 and illustrates an opposing drive gear 7 to cooperate with the drive gear 24 by rotating the drive gear 24. The drive gear 7 may include gear teeth 1101 which may be positioned radially around the periphery of the drive gear 7 and may include a central aperture 1103 to cooperate with a driveshaft 6. An operating arm 1105 may be connected to the driveshaft 6 to rotate the driveshaft 6 and consequently to rotate drive gear 7 and drive gear 24.

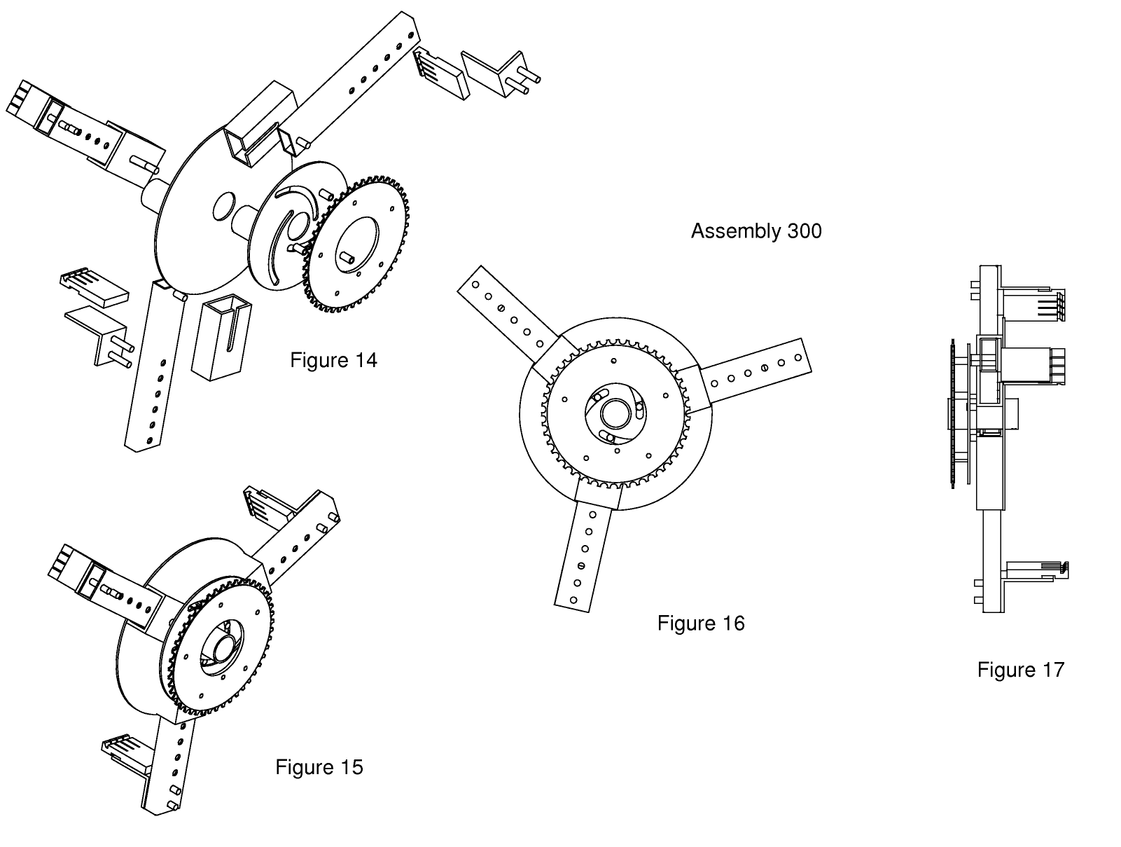

FIG. 14 illustrates an exploded view of among other things the rim locker assembly 300 which may include a base disk member 301 which may be a cylindrical disk and may be connected to a sleeve 307 which may include a slot 309 which may partially extend through the front surface 311 of the sleeve 307. The sleeve 307 may cooperate with a movable arm 301 and the movable arm 301 may include an outward extending finger 305 which extends outwards from the front surface 306 of the movable arm 301 and which may cooperate with the slot 309 of the base member 301 and may cooperate the spiral slots 1132 moves the movable arm 301 radially to adjust for different size tires.

FIG. 15 illustrates a perspective view of the rim locker assembly 300.

FIG. 16 illustrates a front view of the rim locker assembly 300.

FIG. 17 illustrates a side view of the rim locker assembly 300.

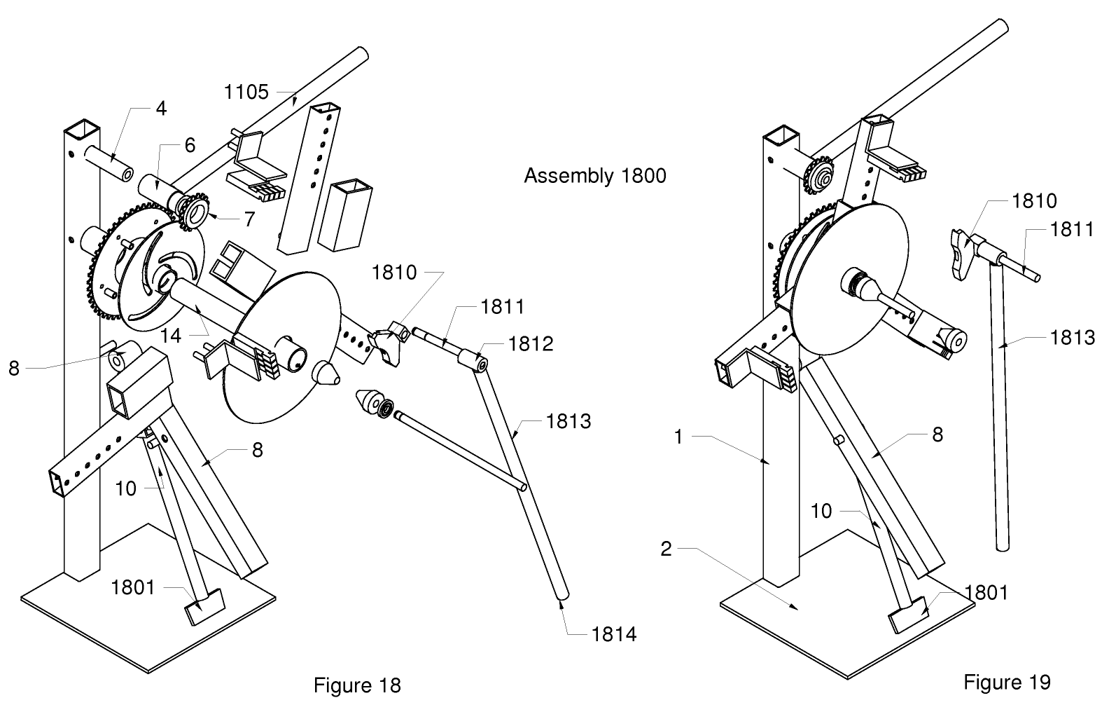

FIG. 18 illustrates an exploded view of the tire changing apparatus 1800 of the present invention. FIG. 18 illustrates a pivoting arm 8 to pivot and to cooperate with connecting rod 10 which may be connected to head 1801 to break the bead of the tire mounted on the wheel of the user.

FIG. 18 additionally illustrates the vertical stand 1 and support 2.

FIG. 18 illustrates the mount/dismount head assembly with the head 1810 connected to the rod 1811. The rod 1811 slides laterally inside the sleeve 1812 which is attached to the top of the rod 1813 to adjust the required space for removing the tire. The rod 1813 is installed vertically with its tip 1814 placed on the ground. The head 1810 is inserted between the tire and the rim of the wheel, firmly held by the assembly placed on the ground. The head is maintained laterally to the wheel by the pression existing between the tire and the rim of the wheel.

A second shaft 4 may be axially aligned with the shaft 6 and may extend through the stand 1 which may be connected to a support 2 to support the stand 1 on a support surface such as a garage floor or ground.

FIG. 19 illustrates a perspective view of the tire changing apparatus 1800.

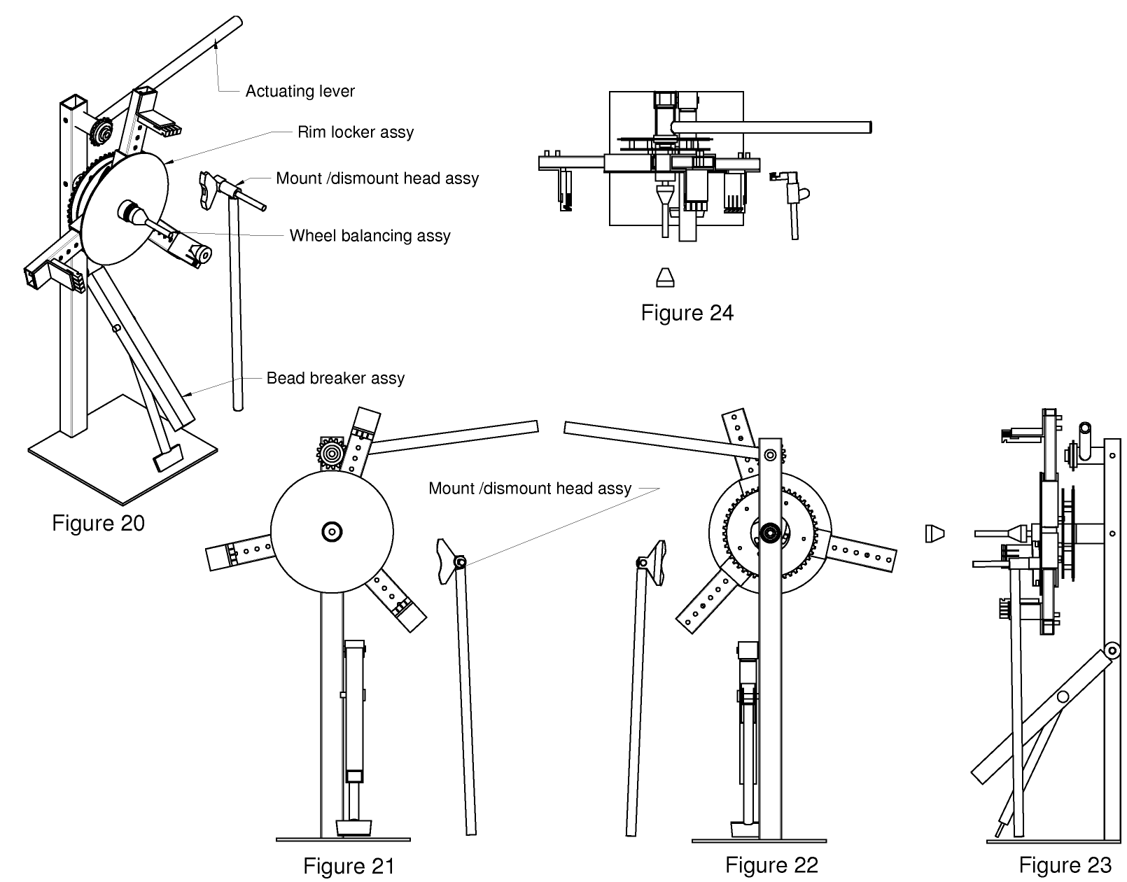

FIG. 20 illustrates a perspective view of the tire changing apparatus 1800.

FIG. 21 illustrates a front view of the tire changing apparatus 1800.

FIG. 22 illustrates a back view of the tire changing apparatus 1800.

FIG. 23 illustrates a side view of the tire changing apparatus 1800.

FIG. 24 illustrates a top view of the tire changing apparatus 1800.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A tire changing apparatus to remove a tire from a wheel, comprising:
a substantially vertical stand for supporting a wheel balancing assembly; and
the vertical stand supporting a rim locker assembly which is operated by a arm.

2) as in claim 1, wherein the rim locker assembly includes an adjustable arm extending device to adjust to different size rims.

3) in claim 1, wherein the rim locker assembly includes rim holders with multiple fingers

4) wherein the arm extending device includes a base member.

5) as in claim 1, wherein the base member includes a spiral slot.

6) as in claim 4, wherein the base member is driven by a drive gear.

7) as in claim 5, wherein the drive gear is driven by a opposing drive gear.

8) as in claim 5, wherein the opposing drive gear is connected to a rotating arm.

9) as in claim 5, wherein the wheeled balancing assembly extends from the center of the drive gear.

10) as in claim 1, wherein the tire changing apparatus includes a tire mounting head assembly.
